(19) United States
(12) Patent Application Publication
(10) Pub. No.: US 2004/0137306 A1
(43) Pub. Date: Jul. 15, 2004

(54) Fuel cell or electrolyser construction

(76) Inventors: Mark Christopher Turpin, Leicestershire (GB); James Charles Boff, Middlesex (GB)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/481,545

(22) PCT Filed: Jun. 12, 2002
(86) PCT No.: PCT/GB02/02747

(30) Foreign Application Priority Data
Jun. 27, 2001 (GB) 0115711.4

(51) Int. Cl. H01M 8/02; C25B 9/00

(52) U.S. Cl. 429/37; 429/38; 204/268; 204/270

(57) ABSTRACT

A fuel cell or electrolyser assembly comprising a fuel cell or electrolyser stack housed in a chamber containing reactant gas, adapted such that in use the reactant gas applies a compensating force to an end face of the stack in opposition to the outwards force of gases within the stack.

This invention relates to fuel cells and electrolysers, and is particularly, although not exclusively, applicable to proton exchange membrane fuel cells and electrolysers.

Fuel cells are devices in which a fuel and an oxidant combine in a controlled manner to produce electricity directly. By directly producing electricity without intermediate combustion and generation steps, the electrical efficiency of a fuel cell is higher than using the fuel in a traditional generator. This much is widely known. A fuel cell sounds simple and desirable but many man-years of work have been expended in recent years attempting to produce practical fuel cell systems. An electrolyser is effectively a fuel cell in reverse, in which electricity is used to split water into hydrogen and oxygen. Both fuel cells and electrolysers are likely to become important parts of the so-called “hydrogen economy”. In the following, reference is made to fuel cells, but it should be remembered that the same principles apply to electrolysers.

One type of fuel cell in commercial production is the so-called proton exchange membrane (PEM) fuel cell [sometimes called polymer electrolyte or solid polymer fuel cells (PEFCs)]. Such cells use hydrogen as a fuel and comprise an electrically insulating (but ionically conducting) polymer membrane having porous electrodes disposed on both faces. The membrane is typically a fluorosulphonate polymer and the electrodes typically comprise a noble metal catalyst dispersed on a carbonaceous powder substrate. This assembly of electrodes and membrane is often referred to as the membrane electrode assembly (MEA) and operates in effect as a unit cell for the fuel cell or electrolyser.

Hydrogen fuel is supplied to one electrode (the anode) where it is oxidised to release electrons to the anode and hydrogen ions to the electrolyte. Oxidant (typically air or oxygen) is supplied to the other electrode (the cathode) where electrons from the cathode combine with the oxygen and the hydrogen ions to produce water.

In commercial PEM fuel cells many such unit cells are stacked together separated by flow field plates (also referred to as bipolar plates). The flow field plates are typically formed of metal or graphite to permit good transfer of electrons between the anode of one membrane and the cathode of the adjacent membrane. This invention is intended to cover any fuel cell or electrolyser using a stack of unit cells and bipolar plates and is not restricted to PEM fuel cells. The flow field plates have a pattern of grooves on their surface to supply fluid (fuel or oxidant) and to remove water produced as a reaction product of the fuel cell. Various methods of producing the grooves have been described, for example it has been proposed to form such grooves by machining, embossing or moulding (WO00/41260), and by sandblasting through a resist (WO01/04982). In a sandblasting system, particles (such as sand, grit, fine beads, or frozen materials) are carried by a blast of air directed towards an article to be treated. The particles travel at a high speed, and on impacting the article abrade the surface.

To ensure that the fluids are dispersed evenly to their respective electrode surfaces a so-called gas diffusion layer (GDL) is placed between the electrode and the flow field plate. The gas diffusion layer is a porous material and typically comprises a carbon paper or cloth, often having a bonded layer of carbon powder on one face and coated with a hydrophobic material to promote water rejection.

An assembled body of flow field plates and membranes with associated fuel and oxidant supply manifolds is often referred to a fuel cell stack. Typically, both the fuel and oxidant are supplied under a pressure of, for example, 300 kPa (˜3 atmospheres). This means that the stack is subject to a bursting pressure of about 200 kPa, being the differential between the fuel and oxidant supply pressures and atmospheric pressure. This bursting pressure tends to drive the flow field plates apart, and so the flow field plates must be clamped together. For some materials (such as graphite) the act of clamping the stack can damage the flow field plates. Accordingly there is a need to reduce the bursting pressure, and hence the clamping pressure.

In solid oxide fuel cell (SOFC) design it is known to provide a plurality of fuel cell modules in a common plenum. The modules are arranged to permit fuel to pass from one end of a module to another, while oxidant gas passes from a central plenum cross-wise to the direction of fuel flow, to an outer chamber from which it is then exhausted. An example of such a system is U.S. Pat. No. 5,480,738 (Assignee—Ceramatec Inc.).

The applicants have realised that, particularly in a PEM fuel cell, the pressure of the reactant gases (fuel and oxidant) can be used to provide a pressure compensating the outward pressure of the reactant gases, so reducing or eliminating the need for a clamping system.

Accordingly, the present invention provides a fuel cell or electrolyser assembly comprising a stack of unit cells and bipolar plates housed in a chamber containing reactant gas, adapted such that in use the reactant gas applies a compensating force to an end face of the stack in opposition to the outward force of gases within the stack.

Advantageously the compensating force is at least 50% of (and preferably at least equal to) the outwards force of the gases within the stack.

Still more advantageously, the compensating force is sufficient that the stack is under compression.

Such an arrangement has further advantages in that the number of fluid connections can be reduced. In one advantageous arrangement, a first reactant gas flows outwardly from a manifold within the fuel cell stack to a first reactant drain and a second reactant gas flows inwardly from the chamber to a second reactant drain.

The invention is illustrated by way of example in the following description with reference to the drawings in which:—

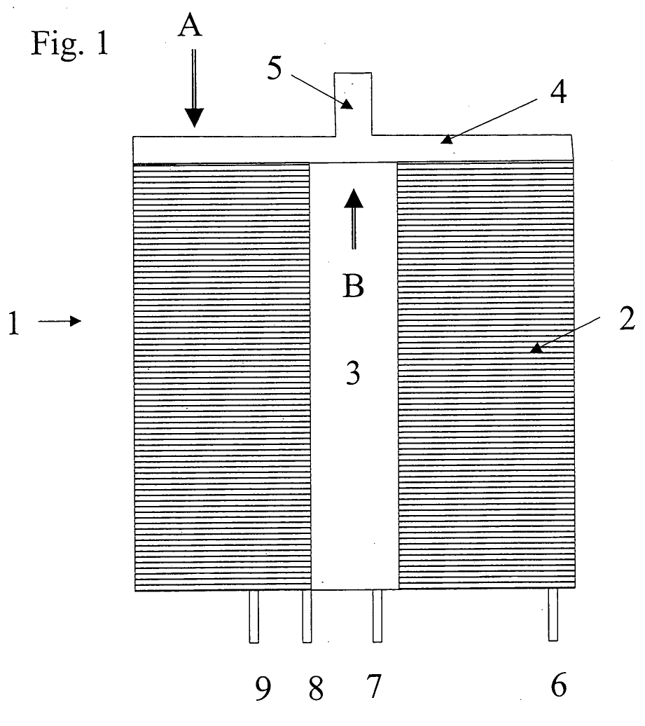

FIG. 1 shows schematically in part section a stack for use in the present invention;

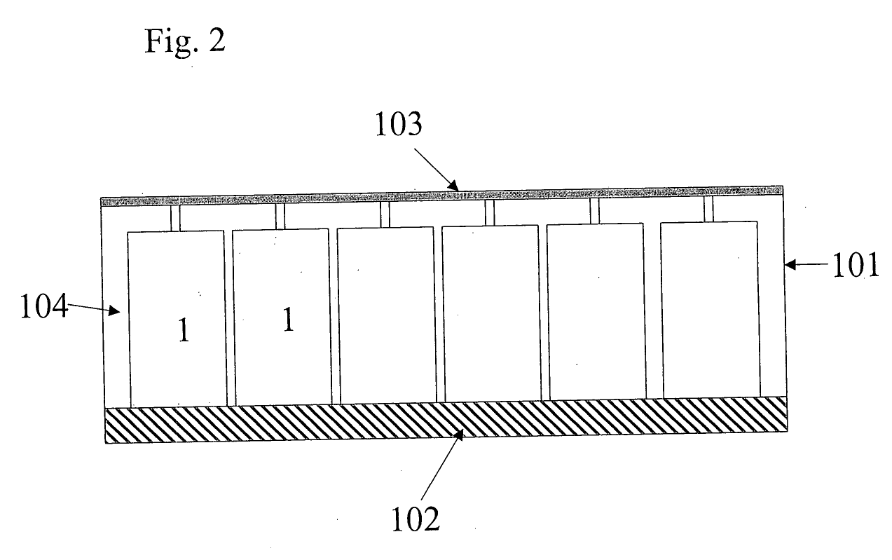

FIG. 2 shows schematically in side view a number of stacks according to FIG. 1 housed in a chamber in accordance with the present invention;

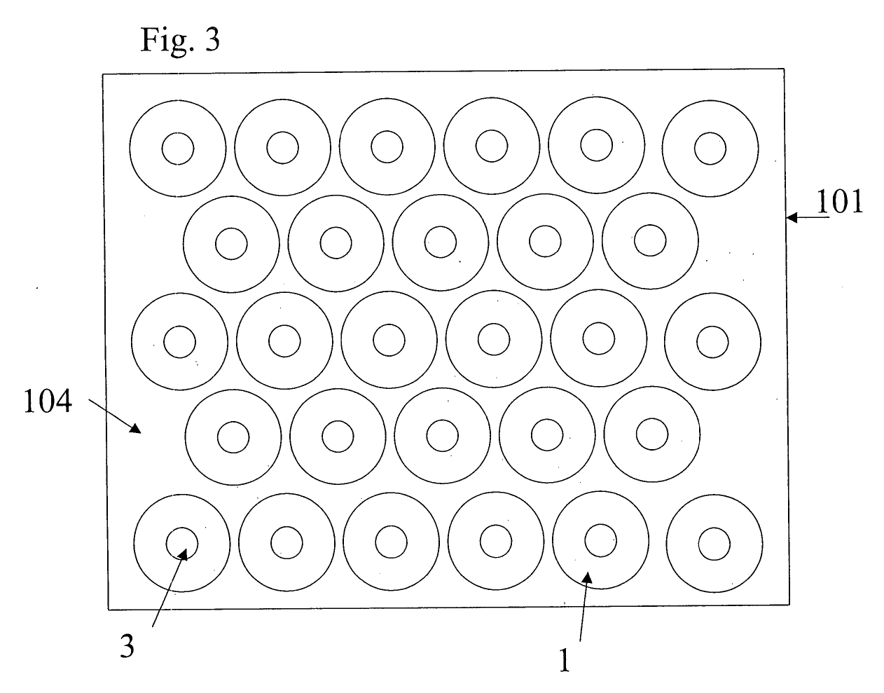

FIG. 3 shows schematically in plan a number of stacks according to FIG. 1 housed in a chamber in accordance with the present invention;

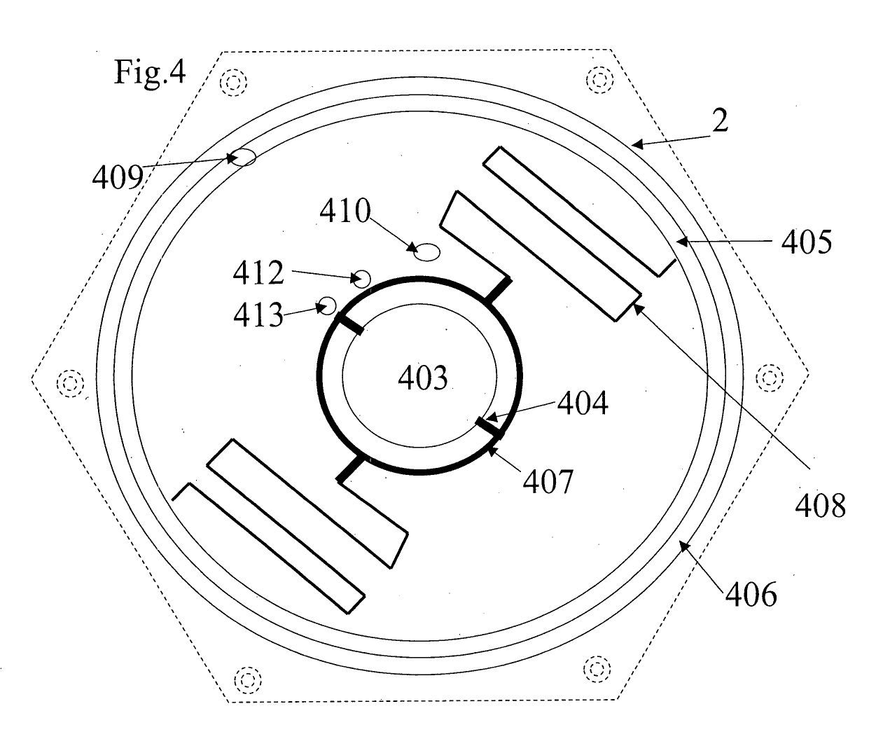

FIG. 4 shows schematically in top plan a fluid flow plate for use in accordance with the invention;

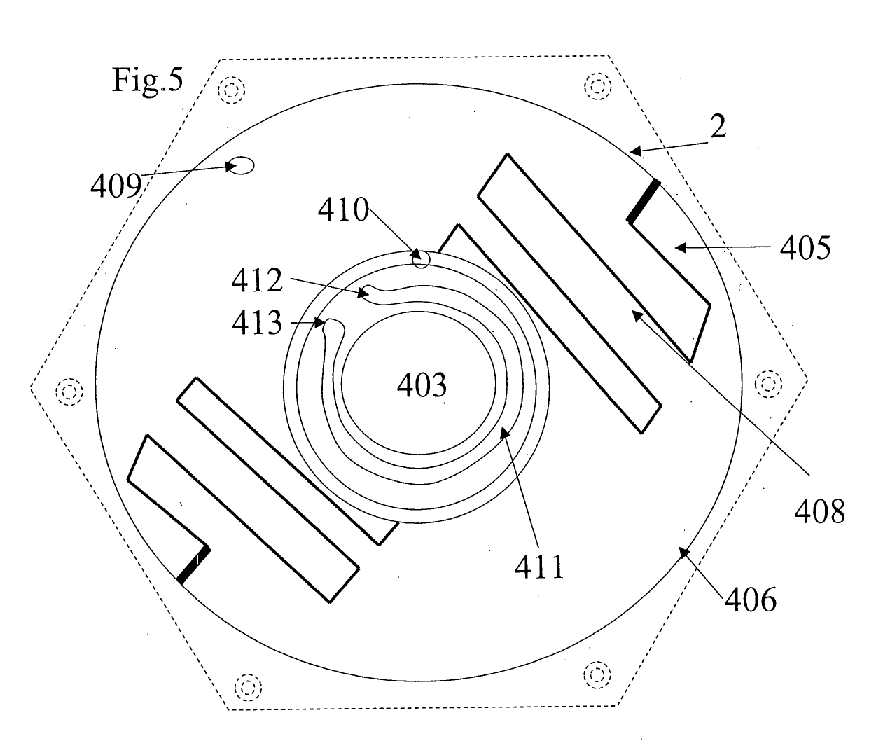

FIG. 5 shows in bottom plan the fluid flow plate of FIG. 4.

FIG; 6 shows schematically a pair of fluid flow plates incorporating a sealing mechanism in accordance with the invention.

A stack 1 (FIG. 1) comprises a plurality of fluid flow plates 2. The fluid flow plates have aligned apertures 403 (FIGS. 4 & 5) forming a fuel supply aperture 3. One end of the stack is terminated by an end plate 4 comprising an electrical connector 5. The end plate 4 closes the end of the fuel supply aperture 3. The stack has connections serving as a fuel outlet 6; an oxidant outlet 7; a coolant inlet 8; and a coolant outlet 9.

Several of the stacks 1 are mounted in a chamber 101 having a system of manifolds 102 for connection to the fuel outlets 6, oxidant outlets 7; coolant inlets 8 and coolant outlets 9. The chamber 101 also has an electrical connection system 103 for connection to the stack electrical connectors 5. A corresponding electrical connection system forming part of the system of manifolds 102 connects to the base of each stack. The chamber 101 and the stacks 1 define between them a void space 104.

Flow field plate 2 is annular and, as stated above, has a central aperture 403. Fuel inlet 404 leads from the aperture 403 to a humidification section 407. From humidification section 407 a flow field 408 leads to a fuel drain 405 (only part shown). Aperture 409 passes through the flow field plate 1 and allows aligned apertures 409 in a stack to form an escape route for surplus fuel leading to fuel outlet 6.

Land 406 is configured to receive seals and this configuration may take place either with the formation of the flow field or in a separate step.

The oxidant flow field on the underside of flow field plate 2 is the reverse, with oxidant flowing in from the outer edge of the flow field plate 402 to an inner drain 407 which connects with aperture 410. Aligned apertures 410 in a stack form an escape route for surplus oxidant leading to oxidant outlet 7. Coolant channel 411 runs from coolant inlet aperture 412 to coolant outlet aperture 413. Aligned coolant inlet apertures 412 in adjacent plates serve to receive coolant from coolant inlet 8 and aligned coolant outlet apertures 413 in adjacent plates serve to pass coolant to coolant outlet 9.

Coolant channel 411 is disposed to lie opposite humidification section 407 of the adjacent flow field plate. By placing a water permeable membrane between the coolant channel 411 and humidification channel 407 incoming hydrogen can be humidified. Sufficient humidification to prevent the membrane drying out is required.

A similar arrangement can be used to humidify incoming oxidant, using a coolant track on the fuel side of the opposed flow field plate. The need for humidification on the oxidant side is less than on the fuel side since water is produced on the oxidant side of the membrane electrode assembly. Some humidification of the oxidant is desirable (to prevent loss of water in the region where the oxidant enters the membrane) but too much humidification is undesirable, as this limits the water carrying capacity of the oxidant.

The water permeable membrane can by e.g. a thin film silicon rubber. The membrane of the membrane electrode assembly could be used in this role.

The pressure of oxidant in the void space 104 will serve to press down on the stack in the direction of arrow “A” in FIG. 1. The pressure of gas within the stack will press outwardly of the stack in the direction “B”, tending to separate the plates of the stack. The compressive force in the direction “A” will tend to counteract the pressure of gas in the direction “B”. Indeed, if the pressures and areas of application are chosen appropriately it is possible for the stack to be under compression. This principle can also be applied to a single stack in a chamber, as well as multiple stacks as exemplified.

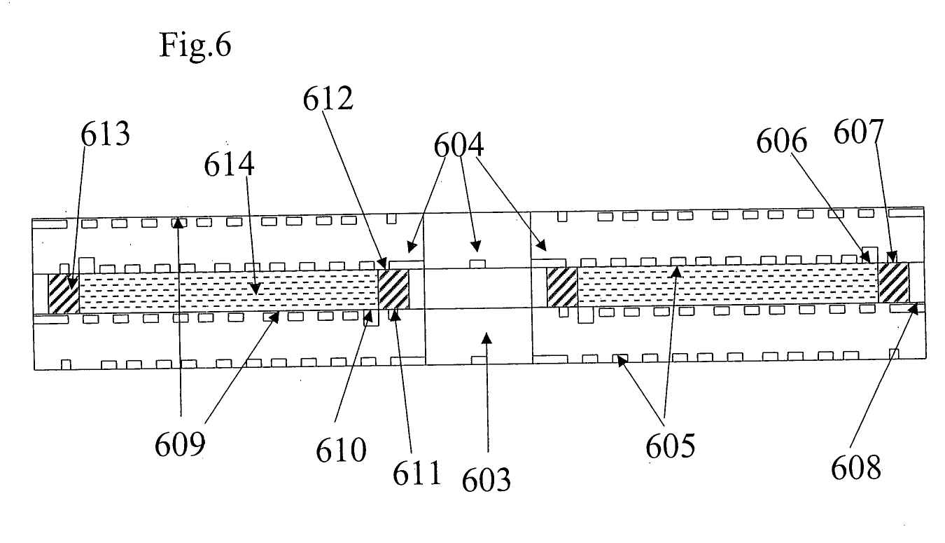

Differential pressures can also be used assist sealing. FIG. 6 shows a pair of flow field plates 601 similar to those of FIGS. 4 and 5. The plates have a central aperture 603 from which fuel inlets 604 extend to an annular path connecting to fuel flow field 605 which drains into a fuel drain 606. A fuel-side sealing groove 607 outwards of the fuel drain 606 connects to the fuel cell drain 606 at several points (not shown). On the oxidant side, oxidant inlets 608 connect with oxidant flow field 609 to oxidant drain 610 and oxidant-side sealing groove 611. Inner and outer seals 612 and 613 are provided bracketing membrane electrode assembly 614 and may be fixed thereto. As the oxidant inlet is at a pressure of e.g. 300 kPa, and as the fuel drain is at a pressure of e.g. 100 kPa (atmospheric) then there will be a net force of 200 kPa urging the sealing ring 613 towards the fuel-side sealing groove 607 which will provide a good seal. Similarly sealing ring 612 will be urged towards the oxidant-side sealing groove 611. The fuel will apply it pressure across the width of the disk up to the fuel-side sealing groove 607. In contrast the oxidant will apply its pressure across effectively the whole width of the disk. accordingly, even when the pressures of fuel and oxidant are the same, unless the electrical connector 5 is of extreme width, the stack will be under net compression.

Of course the whole arrangement can be reversed (oxidant up the middle and fuel at the outside) but for safety reasons the arrangement shown is preferred.

The arrangement described and illustrated is not limited to circular flow field plates, although conventional flow field plates are rectangular in form which gives rise to problems with sealing at the corners. A circular or oval geometry for the seals may be advantageous. A circular arrangement is not ideal for aligning however, and as shown in FIGS. 4 and 5 a hexagonal plate could conveniently be used with fixing holes at the corners to receive threaded rods or other means for aligning or securing the stack. However, as the pressure of gas within the stack is at least partially compensated by the pressure outside the stack, relatively light securing means can be used.

If desired fail safe pressure interlocks can be provided so that the outwards force in direction “B” is always less than the compressive force in direction “A”.

The radial gas flow arrangement of FIGS. 4-6 is advantageous for several reasons (even in a conventional fuel cell without the pressure compensation presently claimed). Firstly one has a countercurrent flow between the fuel and the oxidant which maintains a relatively even pressure differential across the membrane electrode compared with conventional bipolars, which tend to have a cross-flow arrangement. Such a relatively even pressure differential means that the membrane is under a relatively reduced stress: Secondly, the pressure is more evenly distributed across the width of the stack and this means that the forces acting on the bipolar plates are evenly distributed, lessening the risk of a plate breaking or deforming. Further, the evenness of pressure distribution leads to an improved uniformity of electricity generation across the membrane electrode.

Preferred materials for the plate are graphite, carbon-carbon composites, or carbon-resin composites. However the invention is not restricted to these materials and may be used for any material of suitable physical characteristics.

The separate integers and combinations described above may form inventions in their own right.

1. A fuel cell or electrolyser assembly comprising a stack of unit cells and bipolar plates housed in a chamber containing reactant gas, adapted such that in use the reactant gas applies a compensating force to an end face of the stack in opposition to the outward force of gases within the stack.

2. A fuel cell or electrolyser assembly, as claimed in claim 1, in which the compensating force is at least 50% of the outwards force of the gases within the stack.

3. A fuel cell or electrolyser assembly, as claimed in claim 2, in which the compensating force is at least equal to the outwards force of the gases within the stack.

4. A fuel cell or electrolyser assembly, as claimed in any preceding claim, in which the stack is under compression.

5. A fuel cell or electrolyser assembly, as claimed in any preceding claim, in which a first reactant gas flows outwardly from a manifold within the fuel cell stack to a first reactant drain and a second reactant gas flows inwardly from the chamber to a second reactant drain.

6. A fuel cell or electrolyser assembly, as claimed in claim 5, in which incoming gas on a flow field plate urges a sealing ring towards a sealing groove on an adjacent flow field plate maintained at relatively low pressure with respect to the incoming gas.
